(19) United States
(12) Patent Application Publication
(10) Pub. No.: US 2023/0002202 A1
(43) Pub. Date: Jan. 5, 2023

(54) Folding jack stand

(71) Applicant: Wilson Eashoian, Roseville, CA (US)

(72) Inventor: Wilson Eashoian, Roseville, CA (US)

(21) Appl. No.: 17/367,263

(22) Filed: Jul. 2, 2021

(51) Int. Cl. B66F 1/02; B66F 13/00

(52) U.S. Cl. CPC B66F 1/02; B66F 13/00

(57) ABSTRACT

The present invention is a folding jack stand that can be rotated and lifted and is capable of raising heaving machinery from a single point and then locked into a place at the point where it is lifted thus able to raise and hold pressure at the same point.

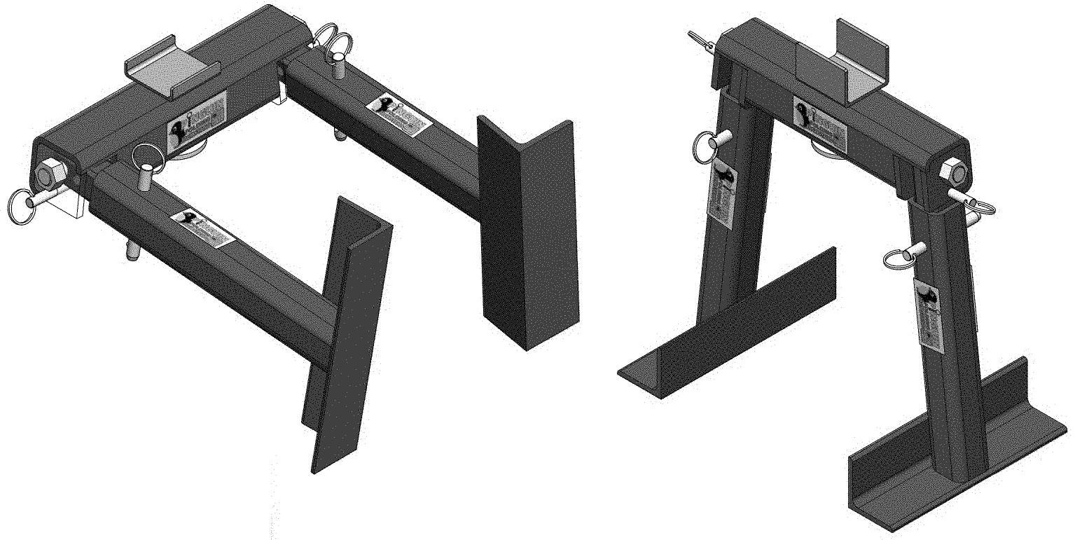

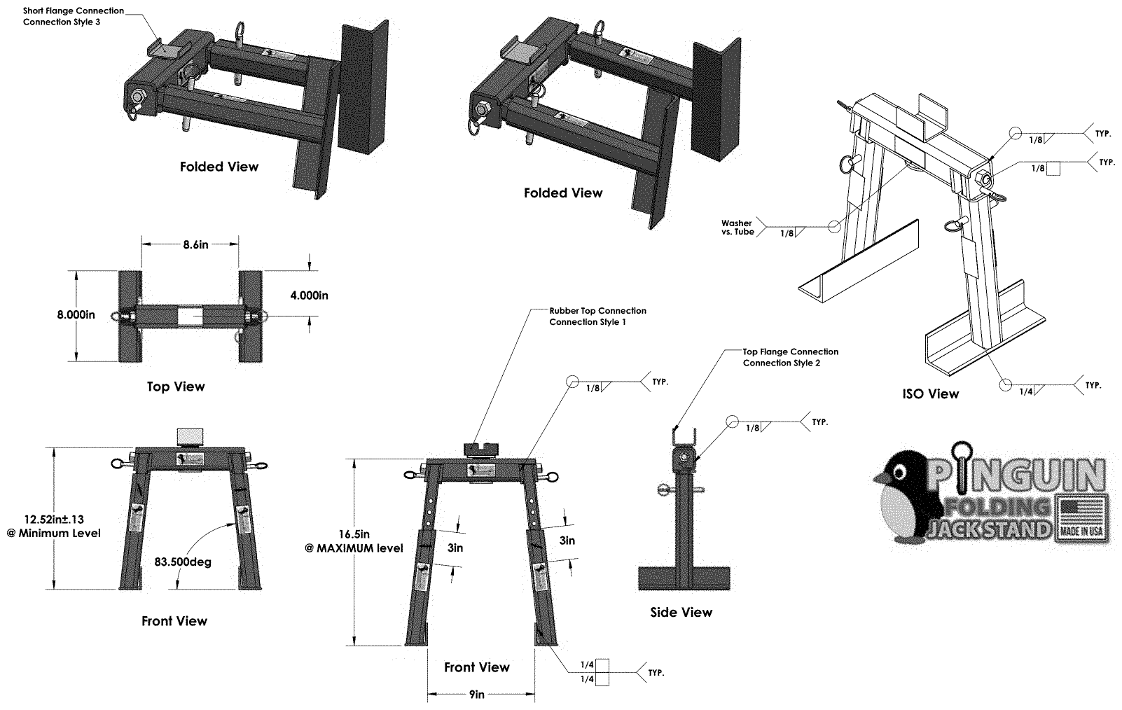

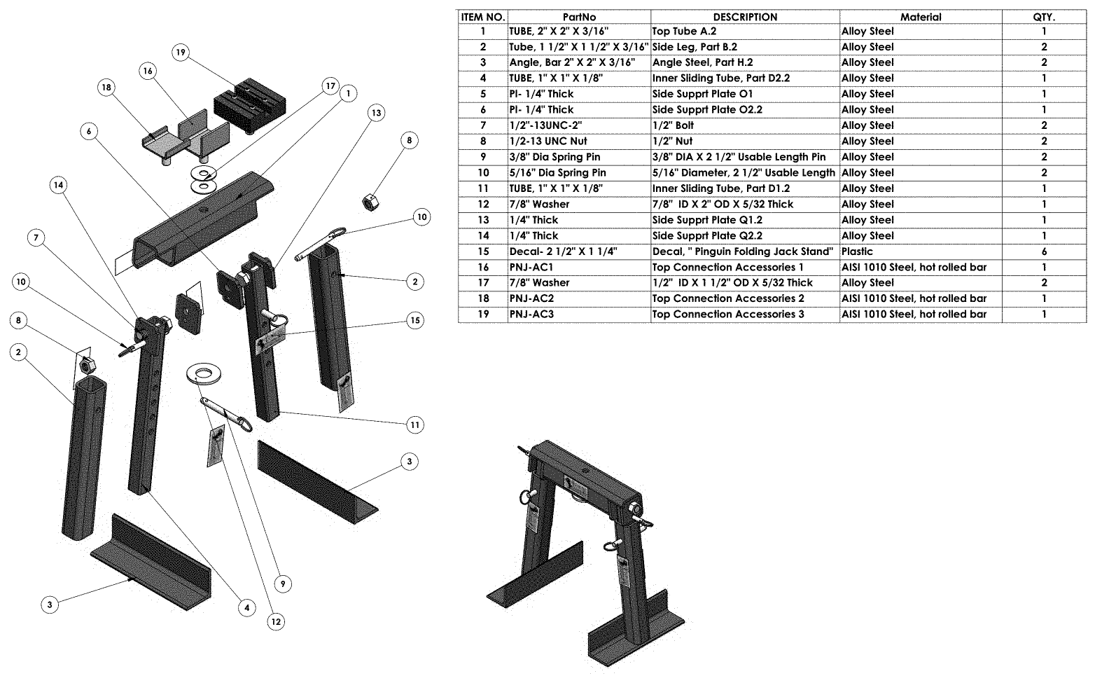

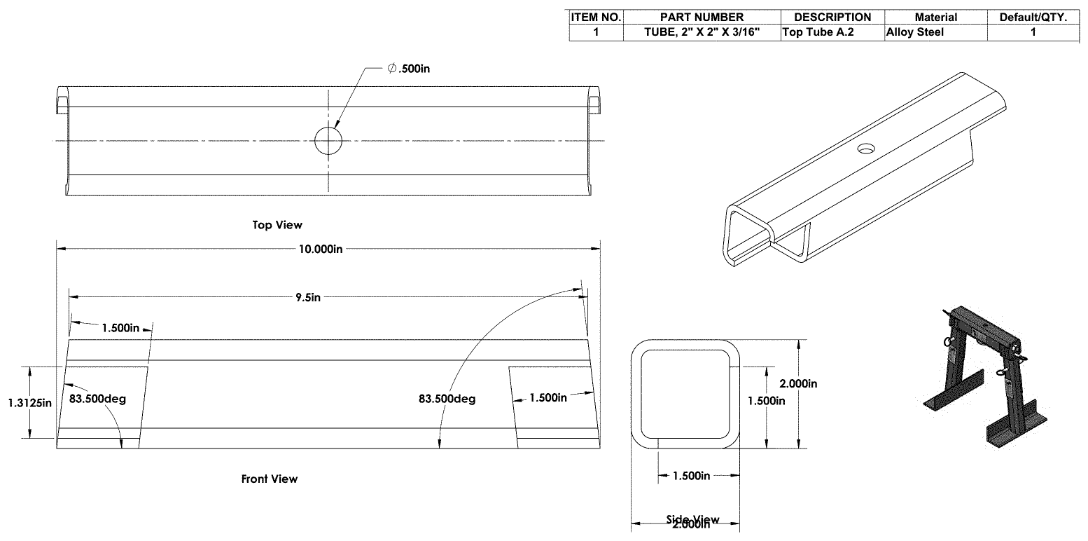

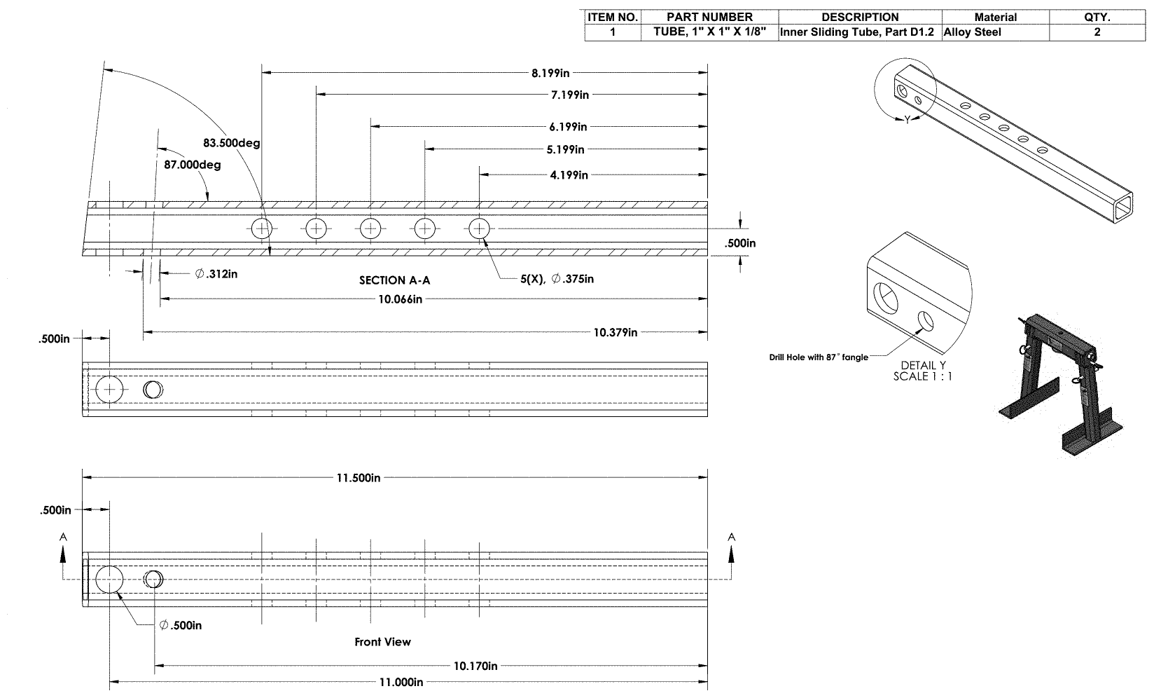

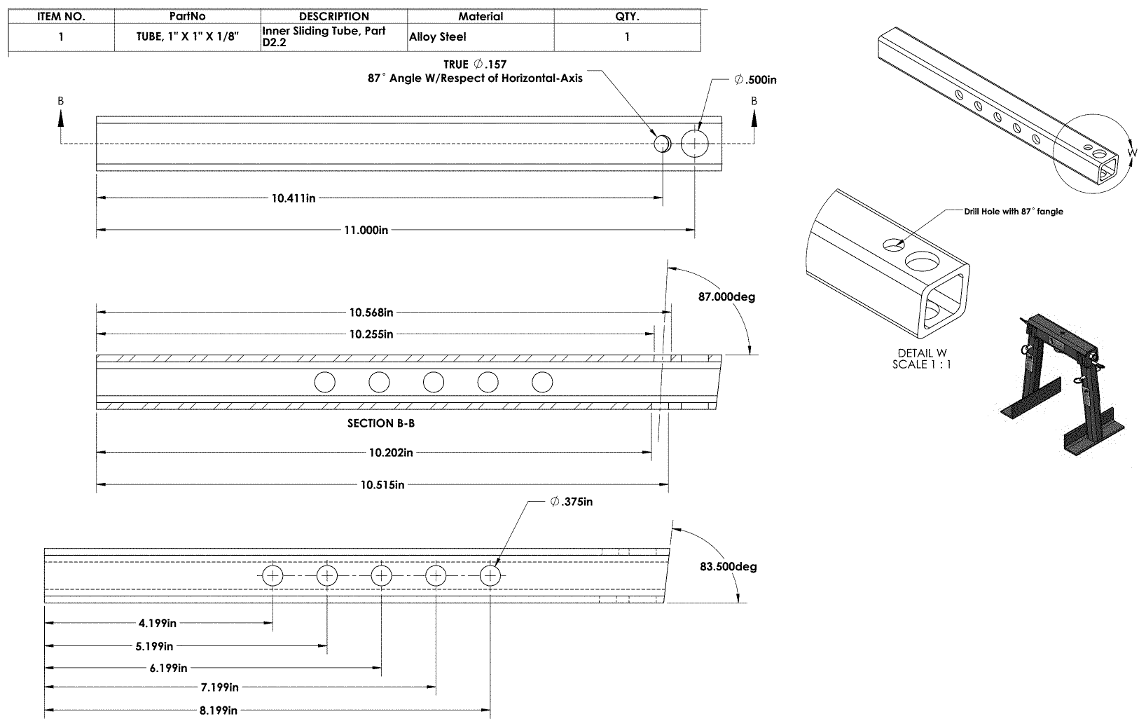

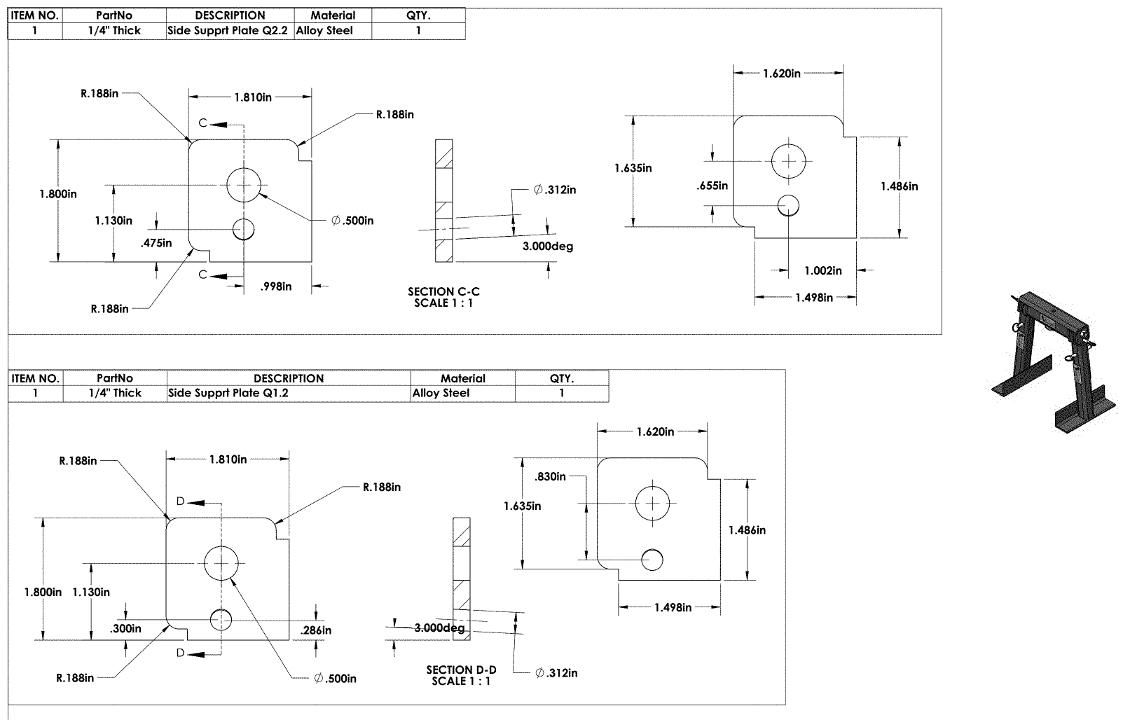

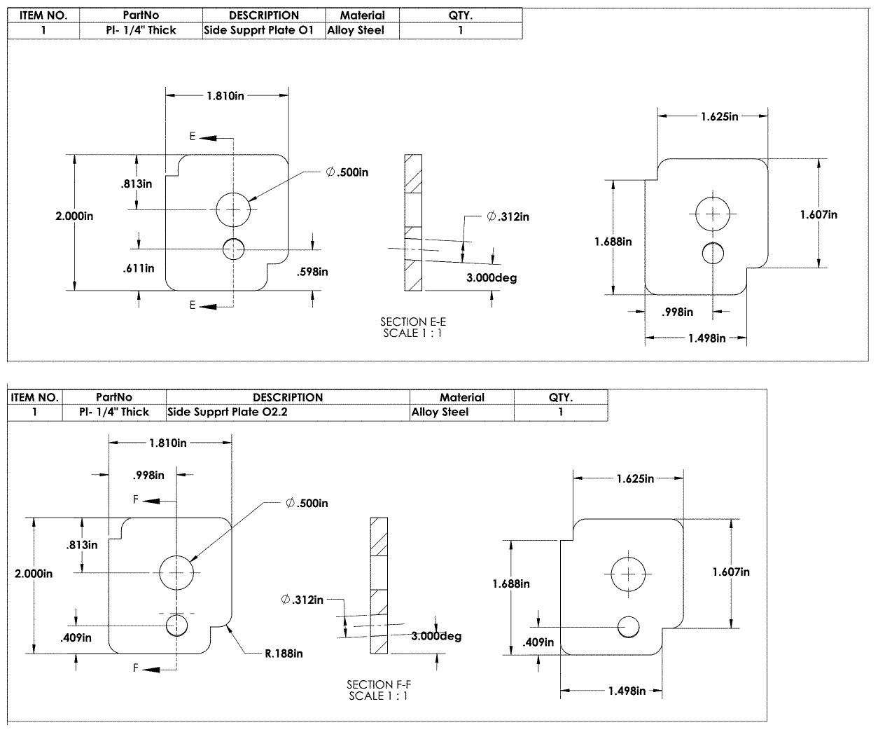

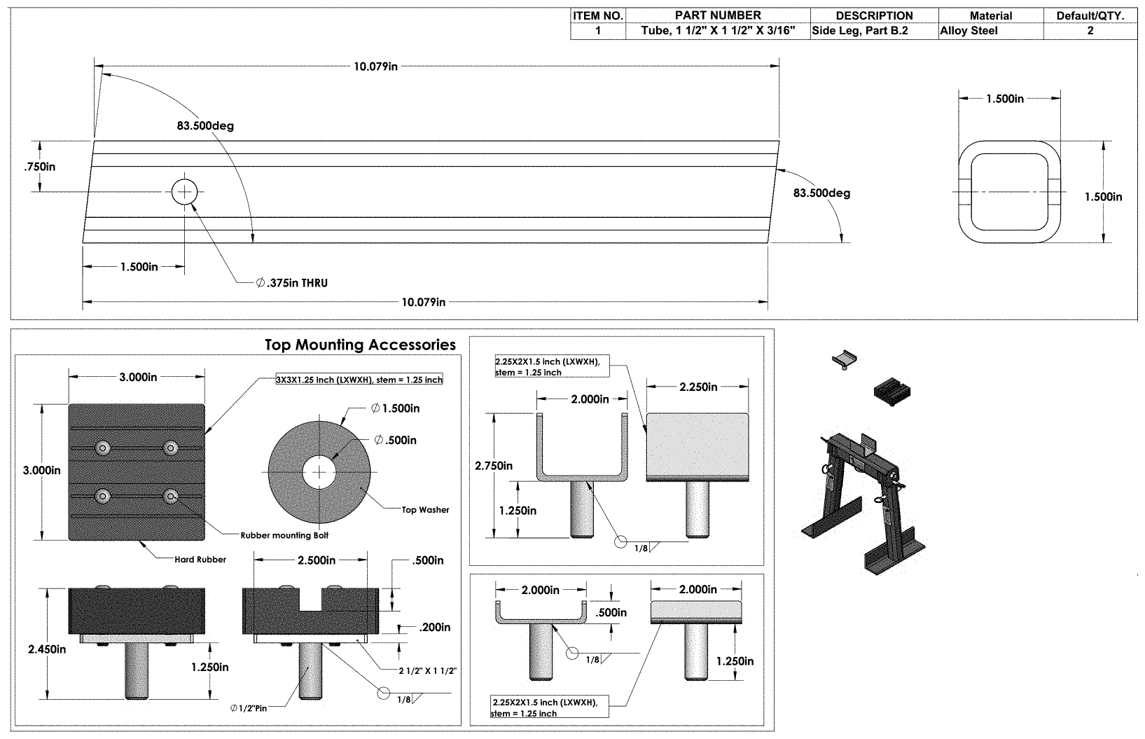

### FIELD OF THE INVENTION

The invention is related to automobile repair and renovation, it deals with working on the components of the car that would most easily be accessed from the underside of the car. Many components of a modern car are more easily reachable through the underside of the car than through any other side, this creates a problem since the underside of the car is not easily accessible from the default state of most modern cars since the clearance between the ground and the underside of the car is too low for any access to most components of the car.

### DESCRIPTION OF THE RELATED ART

While previous patents for jack stands designs exist, a jack stand that uniquely saves space and can be held up at the same point where a car is lifted does not yet exist. This is a benefit as it makes a jack stand more versatile and easier to use.

### SUMMARY OF THE INVENTION

The invention is a jack stand that folds in order to provide greater convenience than other jack stands by being able to be lifted from a point where a car can safely be lifted and held up at. This is done through a mechanism where both legs of the invention fold from a horizontal position into an increasingly vertical position as the car is lifted.

1. A jack stand comprising of two legs attached to a horizontal tube where both legs can rotate (pivot?).

2. The jack stand of claim 1 wherein the base of the legs further comprises a flat metal sheet.

3. The jack stand of claim 1 wherein the top of the horizontal tube further comprises a u-shaped receptacle.

4. The jack stand of claim 1 wherein the horizontal tube has two holes for locking the rotation of the legs using locking pins.

5. The jack stand of claim 1 wherein the horizontal tube can be raised upwards.

6. The jack stand of claim 5 wherein the height can be locked in using locking pins.
